(19) United States
(12) Patent Application Publication
(10) Pub. No.: US 2025/0028998 A1
(43) Pub. Date: Jan. 23, 2025

(54) UTILIZING DYNAMIC DATA SAMPLING TO IMPLEMENT MACHINE LEARNING MODELS FOR PROJECTING RECURRENCE OF PERIODIC EVENTS

(71) Applicant: Chime Financial, Inc., San Francisco, CA (US)

(72) Inventors: Joanna Chao, Santa Cruz, CA (US); Kyle Patrick Daley, Incline Village, NV (US); Hadi Ramezani Dakhel, San Francisco, CA (US)

(21) Appl. No.: 18/353,633

(22) Filed: Jul. 17, 2023

(51) Int. Cl. G06N 20/00

(52) U.S. Cl. CPC G06N 20/00

(57) ABSTRACT

The present disclosure relates to systems, non-transitory computer-readable media, and methods for projecting recurrence of periodic events. For example, embodiments of the disclosed systems determine that a target account qualifies for an account definition based on an account event occurring within a defined threshold time period, the account event being a periodic event of an unknown frequency. In one or more embodiments, based on determining the target account qualified for the account definition, the disclosed systems identify a set of features associated with the target account and based on the set of features, utilize a recurrence prediction machine learning model to generate a recurrence score that indicates a likelihood that the account event will repeat within the target account.

### BACKGROUND

Recent years have seen significant improvements in conventional systems for training and implementing machine learning models. For example, conventional systems utilize a variety of machine learning models with learned parameters trained to perform various prediction tasks. To illustrate, conventional systems utilize decision tree or neural network machine learning approaches to generate predictions or classifications regarding network accounts, clients, client devices, or related events. For instance, some conventional systems utilize machine learning models to estimate the likelihood that an account event will take place or repeat within a network account. Although these conventional systems are able to generate and utilize predictive machine learning models, they have a number of technical deficiencies in relation to accuracy, efficiency, and flexibility of implementing computing devices.

For instance, conventional systems often utilize machine learning models that generate inaccurate predictive results. In particular, ground truth data is often difficult to obtain for models that predict the occurrence and/or recurrence of typically periodic events for which the event frequency is unknown. In addition, conventional systems are often inefficient, frequently leading to an inefficient utilization of computer resources, particularly when training models with extensive amounts of historical data. Also, conventional systems are often inflexible and rigid. For instance, as mentioned above, conventional systems that utilize machine learning models are often limited in scope to projecting events for which records of historical patterns are readily available.

These along with additional problems and issues exist with regard to conventional account classification or event prediction systems.

### BRIEF SUMMARY

Embodiments of the present disclosure provide benefits and/or solve one or more of the foregoing or other problems in the art with systems, non-transitory computer-readable media, and methods for projecting recurrence of events within network accounts. In particular, the disclosed systems utilize recurrence prediction machine learning models to predict the likelihood of whether a periodic event of unknown frequency will repeat. For example, in one or more implementations the disclosed systems detect that an account event has occurred within a target account, determine a set of features associated with the target account, and utilize a recurrence prediction machine learning model to generate a recurrence score that indicates a likelihood that the account event will repeat within the target account. In one or more embodiments, the disclosed systems train a recurrence prediction machine learning model to predict recurrences of periodic events utilizing historical data corresponding to a sample population of accounts by sampling the historical data according to one or more assumed frequencies for the periodic event. In addition, in some embodiments, the disclosed systems utilize a recurrence incentive model to determine actions, based on recurrence scores generated by a recurrence prediction machine learning model, for increasing (or decreasing) the likelihood that an event will repeat. Accordingly, the disclosed systems improve the accuracy, efficiency, and flexibility of predictive machine learning models and implementing computing devices.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which an event recurrence projection system can operate in accordance with one or more embodiments.

FIG. 2 illustrates an event recurrence projection system utilizing a recurrence prediction machine learning model in accordance with one or more embodiments.

FIG. 3 illustrates an exemplary list of input account features for determining recurrence scores in accordance with one or more embodiments.

FIG. 4 illustrates an event recurrence projection system determining a recurrence score for an account event and determining responsive actions in accordance with one or more embodiments.

FIG. 5 illustrates an event recurrence projection system utilizing a sample population of accounts to train a prediction machine learning model in accordance with one or more embodiments.

FIG. 6 illustrates an event recurrence projection system utilizing a dynamic prediction window to train a prediction machine learning model in accordance with one or more embodiments.

FIGS. 7A-7C illustrate an exemplary list of input account features for determining recurrence scores in an example application of the event recurrence projection system in accordance with one or more embodiments.

FIG. 8 illustrates a flowchart of a series of acts for utilizing an event recurrence projection system to predict event recurrences in accordance with one or more embodiments.

FIG. 9 illustrates a block diagram of an example computing device for implementing one or more embodiments of the present disclosure.

FIG. 10 illustrates an example environment for an event recurrence projection system in accordance with one or more embodiments.

### DETAILED DESCRIPTION

This disclosure describes one or more embodiments of an event recurrence projection system that predicts a likelihood of recurrence for periodic events of unknown frequency. For example, embodiments of the event recurrence projection system utilize a recurrence prediction machine learning model to generate recurrence scores indicating a likelihood that an event will repeat within target accounts. Model inputs can include various account features derived from data provided by a variety of sources. In addition, some embodiments of the disclosed systems utilize a recurrence incentive model to determine actions, based on generated recurrence scores, for increasing (or decreasing) the likelihood that an event will repeat within target accounts. In one or more embodiments, the disclosed systems train a recurrence prediction machine learning model based on historical data sampled according to one or more assumed values of an unknown frequency for periodic events. In this manner, the disclosed systems improve the accuracy, efficiency, and flexibility of computing devices in training and implementing predictive machine learning models.

In some embodiments, for example, the event recurrence projection system determines that a target account qualifies for an account definition based on an account event occurring within a defined threshold time period, the account event being a periodic event of an unknown frequency. In response to determining the account qualified for the account definition, the event recurrence projection system identifies a set of features associated with the target account and utilizes a recurrence prediction machine learning model to generate a recurrence score, based on the set of features, that indicates a likelihood that the account event will repeat within the target account.

Moreover, in one or more embodiments, the event recurrence projection system trains a recurrence prediction machine learning model utilizing historical data corresponding to a sample population of accounts by sampling the historical data according to a dynamic prediction window, based on one or more assumed values of the unknown frequency. In addition, in some embodiments, the event recurrence projection system utilizes a recurrence incentive model to determine one or more actions, based on a recurrence score and/or one or more features from an associated set of features, for increasing (or decreasing) the likelihood that the account event will repeat within the target account.

The event recurrence projection system provides many advantages and benefits over conventional systems and methods. For example, by utilizing a dynamic prediction window to train a recurrence prediction machine learning model, the event recurrence projection system improves accuracy relative to conventional systems. Specifically, embodiments of the event recurrence projection system utilize a dynamic prediction window corresponding to one or more assumed values of an unknown frequency of periodic events to sample historical data associated with a sample population of accounts. Embodiments of the event recurrence projection system utilize the dynamically sampled historical data to train a recurrence prediction machine learning model that can predict recurrence of unknown periodic events with increased accuracy compared to conventional predictive models. In addition, by utilizing a recurrence incentive model to intelligently determine responsive actions for increasing (or decreasing) the likelihood that an account event will repeat within a target account, the event recurrence projection system improves the accuracy and effectiveness of such actions.

Furthermore, by utilizing a dynamic prediction window to train a recurrence prediction machine learning model, the event recurrence projection system also improves efficiency relative to conventional systems. In particular, embodiments of the event recurrence projection system efficiently and effectively sample historical data for model training in a manner that is most relevant to the prediction of periodic events of unknown frequency. Indeed, by parsing (i.e., sampling) ground truth data according to the disclosed embodiments, the disclosed systems can reduce training time and computing resources relative to conventional systems utilizing predictive machine learning models.

Moreover, by sampling historical data according to one or more assumed values of an unknown frequency for periodic events (i.e., utilizing a dynamic prediction window), the event recurrence projection system exhibits increased flexibility relative to conventional systems. For instance, embodiments of the event recurrence projection system can be implemented to project recurrence of periodic account events of virtually any unknown frequency. Also, the disclosed embodiments can be implemented in a variety of environments, such as but not limited to a variety of financial networks, information databases, online members-only associations, and so forth.

As illustrated by the foregoing discussion, the present disclosure utilizes a variety of terms to describe features and advantages of the event recurrence projection system. Additional detail is now provided regarding the meaning of such terms. For example, as used herein, the terms “network account” and “account” refers to a computer environment or location with personalized digital access to a web application, a native application installed on a client device (e.g., a mobile application, a desktop application, a plug-in application, etc.), or a cloud-based application. In particular embodiments, a network account includes a financial payment account through which a user can initiate a network transaction (e.g., an electronic payment for goods or services) on a client device or with which another user can exchange tokens, currency, or data. Examples of a network account include a CHIMER account.

Also, as used herein, the term “account event” refers to an event, occurrence, or incident that is enacted by, enacted upon, perpetuated by, caused by, implemented within, or otherwise associated with a network account. In particular embodiments, account events are periodic events that generally occur according to a particular frequency, such as but not limited to, for example, once every 24 hours, 7 days, 14 days, one calendar month, one fiscal or calendar year, and so forth. As a non-limiting example, an account event can be a financial transaction, such as a loan payment, a direct deposit of funds, a scheduled transfer of funds, and so forth.

Relatedly, as used herein, the term “network transaction” refers to a transaction performed as part of a digital exchange of funds, tokens, currency, or data between accounts or other connections of a computing system. In particular embodiments, the network transaction can be a mobile check deposit (e.g., a digital request for executing a check that can transfer funds from a check maker account to a recipient account), a direct deposit of a paycheck, a peer-to-peer (P2P) transfer of funds (e.g., a digital request for executing a direct transfer of funds from a financial account of a requesting user to a financial account of associated with another user), a purchase by credit or debit, a withdrawal of cash, and so forth. Indeed, a network transaction can be implemented via a variety of client devices. In some embodiments, the network transaction may be a transaction with a merchant (e.g., a purchase transaction) in which a merchant or payee indicated on a transaction request corresponds to the recipient account.

As used herein, the term “account definition” refers to a designation or classification of a network account. For example, an account definition includes a designation that a particular account event has occurred at least once within a network account. In some cases, such designations are contingent on more than one characteristic, such as the occurrence of a particular event within a threshold period of time.

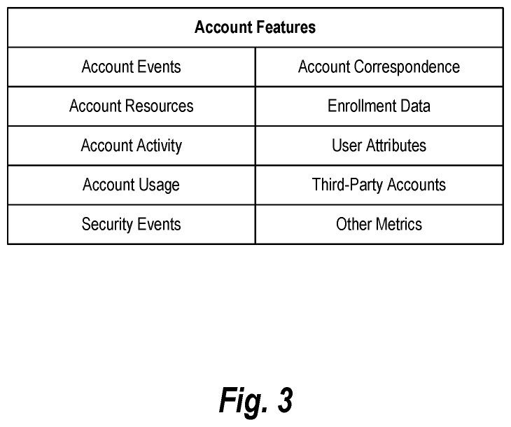

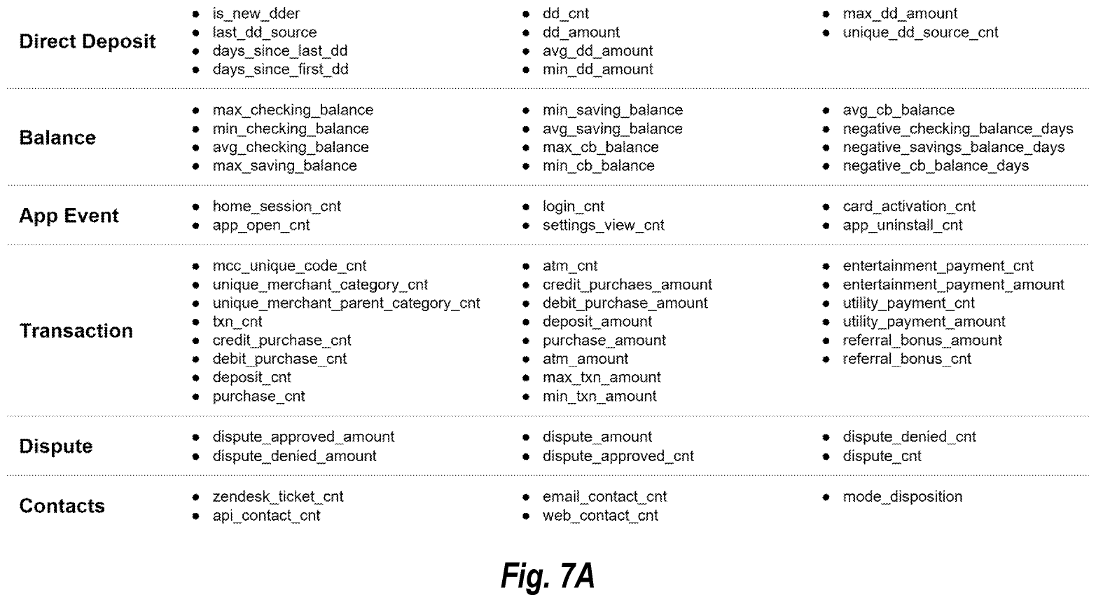

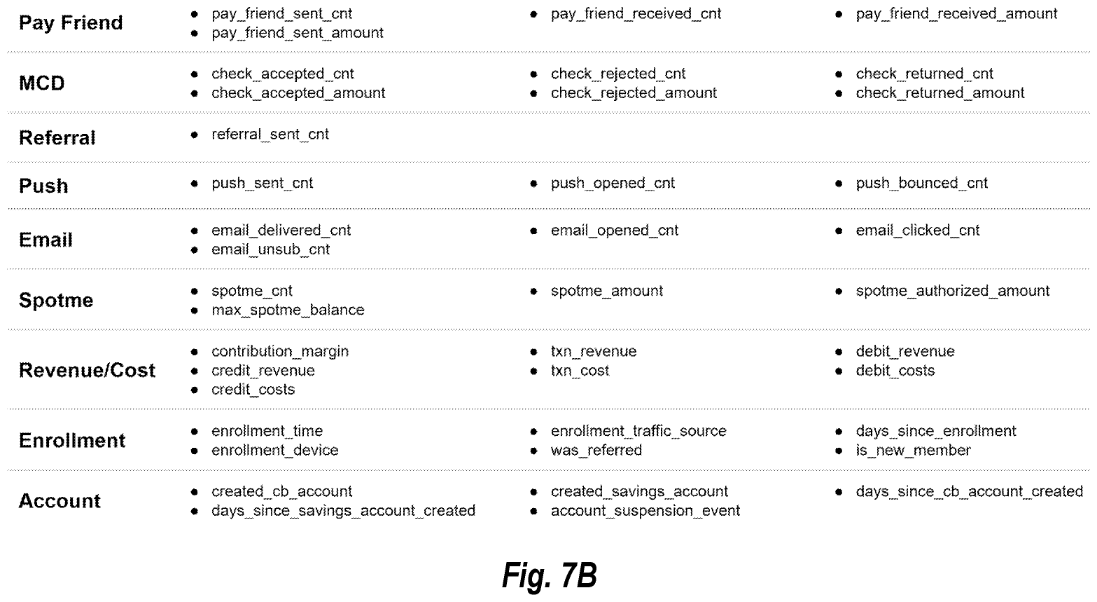

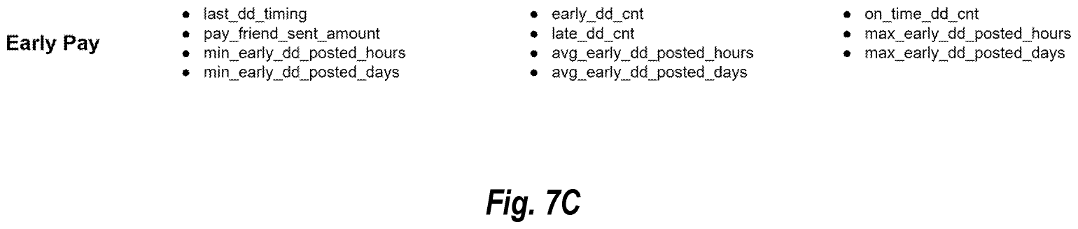

As used herein, the term “feature” refers to characteristics or attributes related to a network account or account event. In particular embodiments, a feature includes account-based characteristics associated with an account holder (i.e., user) and/or a computing device associated with the network account and/or the account holder (e.g., a user computing device utilized to request/create the network account and/or to perform account events, such as but not limited to network transactions). Additional non-limiting examples of features are discussed below in relation to FIGS. 3 and 7A-7C.

As used herein, the term “machine learning model” refers to a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees (e.g., decision trees, random forests, gradient boosting models, and so forth), support vector machines, Bayesian networks, linear regressions, logistic regressions, random forest models, or neural networks (e.g., deep neural networks).

As used herein, the term “neural network” refers to a machine learning model of interconnected artificial neurons (e.g., organized in layers) that communicate and learn to approximate complex functions and generate outputs based on a plurality of inputs provided to the neural network. In some cases, a neural network refers to an algorithm (or set of algorithms) that implements deep learning techniques to model high-level abstractions in data. For example, a neural network includes a multi-layer perceptron, a transformer neural network, a convolutional neural network, a recurrent neural network (e.g., an LSTM), a graph neural network, or a generative adversarial neural network.

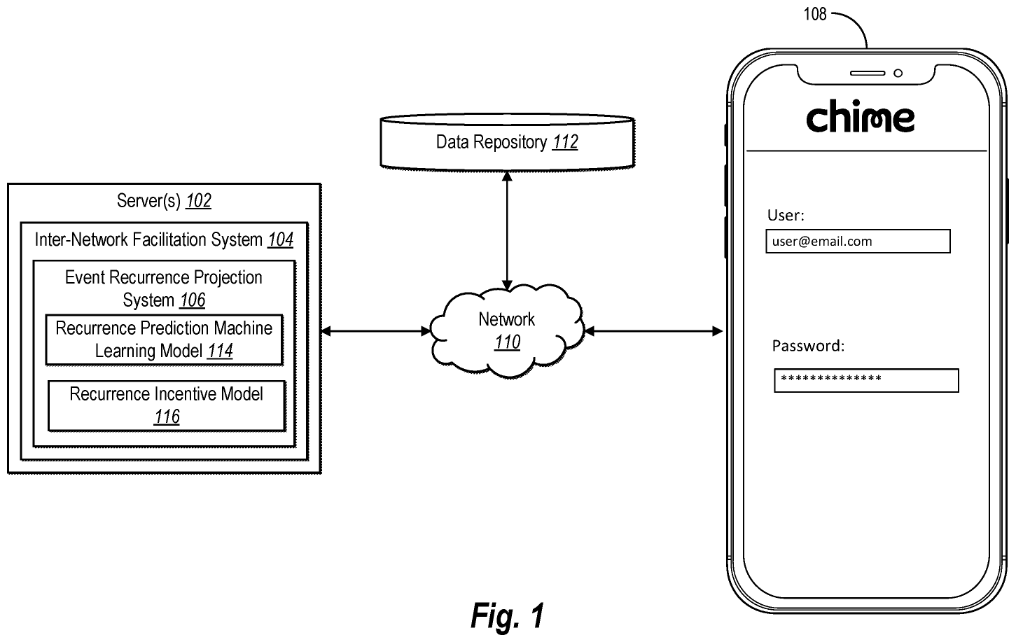

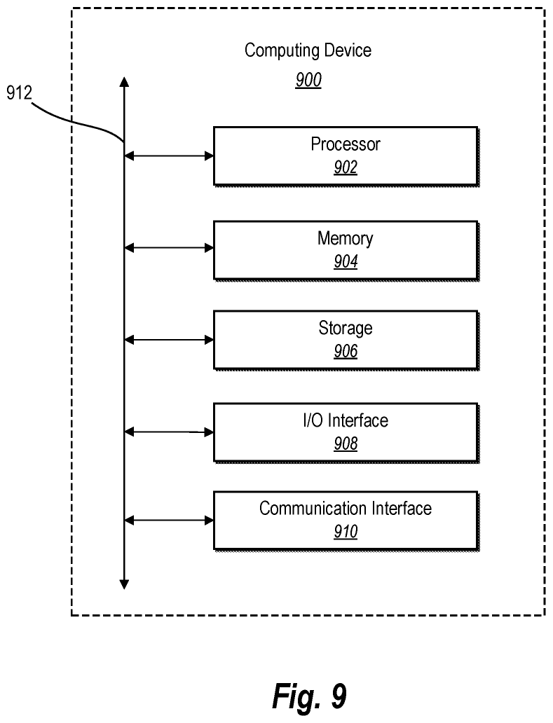

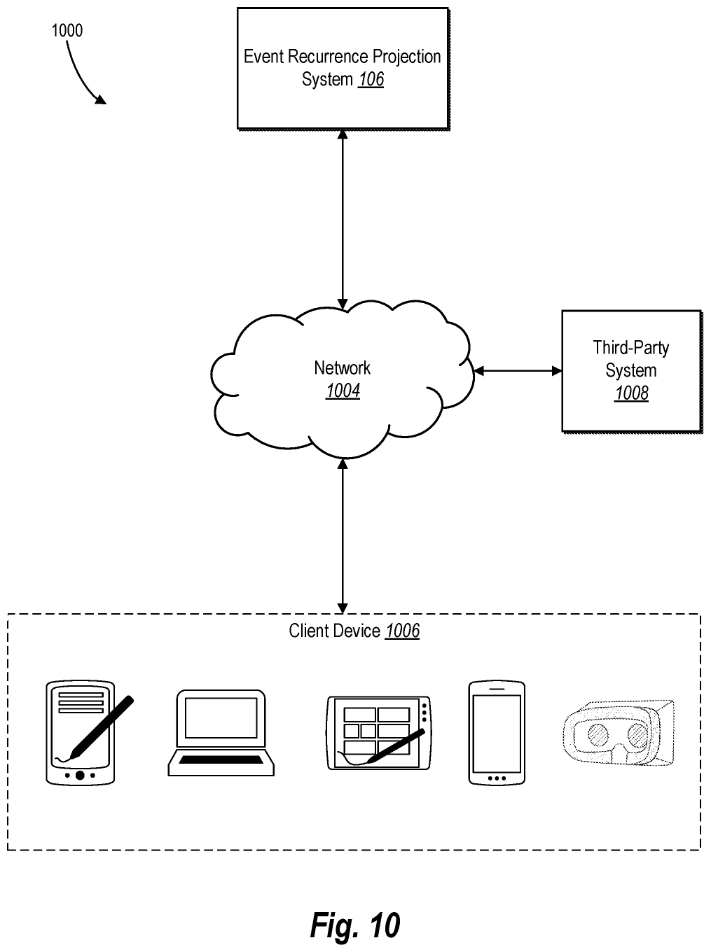

Additional detail regarding the event recurrence projection system will now be provided with reference to the figures. In particular, FIG. 1 illustrates a computing system environment for implementing an event recurrence projection system 106 in accordance with one or more embodiments. As shown in FIG. 1, the environment includes server(s) 102, client device 108, a network 110, and a data repository 112. In some embodiments, the environment includes additional systems connected to the event recurrence projection system 106, such as an account management system, a security system, and so forth. The server(s) 102 can include one or more computing devices (and a database) to implement the event recurrence projection system 106. Additional description regarding the illustrated computing devices (e.g., the server(s) 102, the client device 108, and/or the data repository 112) is provided below in relation to FIGS. 9-10.

As shown in FIG. 1, the event recurrence projection system 106 utilizes the network 110 to communicate with the client device 108 and/or the data repository 112. The network 110 may comprise, for example, any network described in relation to FIGS. 9-10 below. For example, the server(s) 102 communicates with the client device 108 to provide and receive information pertaining to network accounts, account events, account features, and so forth.

As illustrated, the event recurrence projection system 106 evaluates data from various sources, such as the client device 108 and the data repository 112, to project (i.e., predict and incentivize or disincentivize) recurrence of account events. Additional inputs to the event recurrence projection model include but are not limited to data from third-party applications, server-side data repositories, user-provided inputs from devices other than the client device 108, and so forth.

As indicated by FIG. 1, the client device 108 includes a client application. In many embodiments, the event recurrence projection system 106 communicates with the client device 108 through the client application to, for example, receive and provide information including event and feature data pertaining to a target account. In addition, the event recurrence projection system 106 can receive information from the data repository 112, such as historical data associated with a sample population of accounts.

As indicated above, the event recurrence projection system 106 can provide (and/or cause the client device 108 to display or render) visual elements within a graphical user interface associated with the client application. For example, the event recurrence projection system 106 can provide a graphical user interface that includes a login screen and/or an option to request/create a new account. In some cases, the event recurrence projection system 106 provides user interface information for a user interface for performing enacting account events to be considered by the event recurrent projection system 106. As described in greater detail below, in some embodiments, the event recurrence projection system 106 also utilizes the recurrence incentive model 116 to determine appropriate actions for incentivizing (or disincentivizing) recurrence of an account event. In some cases, for example, the event recurrence projection system 106 performs one or more actions, as determined by the recurrence incentive model 116, through the client device 108, such as but not limited to: providing an incentive to a user of the target account, providing information associated with the account definition to the user of the target account, or activating one or more application features associated with the target account.

Although FIG. 1 illustrates the environment having a particular number and arrangement of components associated with the event recurrence projection system 106, in some embodiments, the environment may include more or fewer components with varying configurations. For example, in some embodiments, the event recurrence projection system 106 can communicate directly with the client device 108 and/or the data repository 112, bypassing the network 110. Further, the event recurrence projection system 106 can include more network components communicatively coupled together.

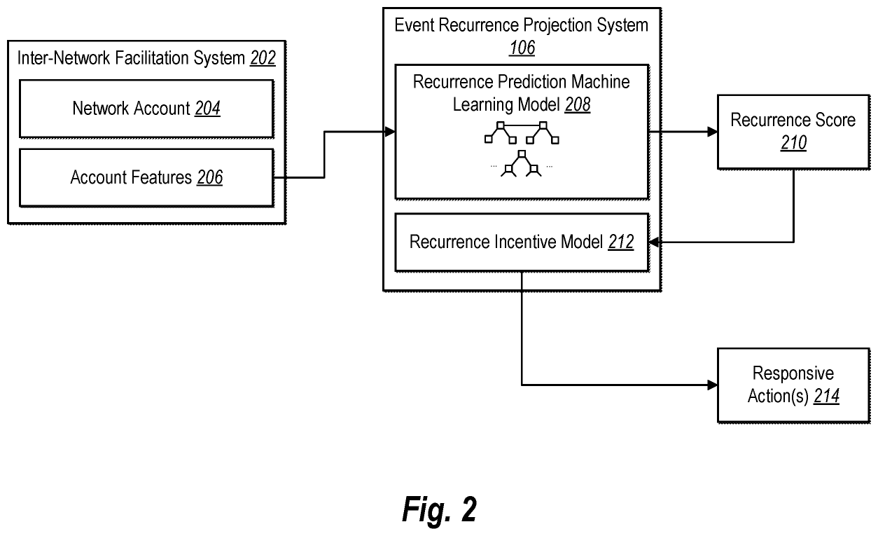

As discussed above, the event recurrence projection system 106 can generate a recurrence score based on account features of a target account and implement one or more responsive actions to increase (or decrease) the likelihood that an account event will repeat within the target account. For instance, FIG. 2 illustrates the event recurrence projection system 106 utilizing a recurrence prediction machine learning model 208 to generate a recurrence score 210 based on account features 206 associated with a network account 204 (i.e., a target account). In addition, FIG. 2 shows the event recurrence projection system 106 utilizing a recurrence incentive model 212 to determine and/or implement one or more responsive actions 214.

As illustrated, an inter-network facilitation system 202 includes (or monitors) the network account 204 for account events. For example, the inter-network facilitation system 202 can include but is not limited to a network management system, such as a database, a financial network, a membership network, a content management network, and so forth. In addition, as illustrated, the inter-network facilitation system 202 includes (or has access to) the account features 206 associated with the network account 204.

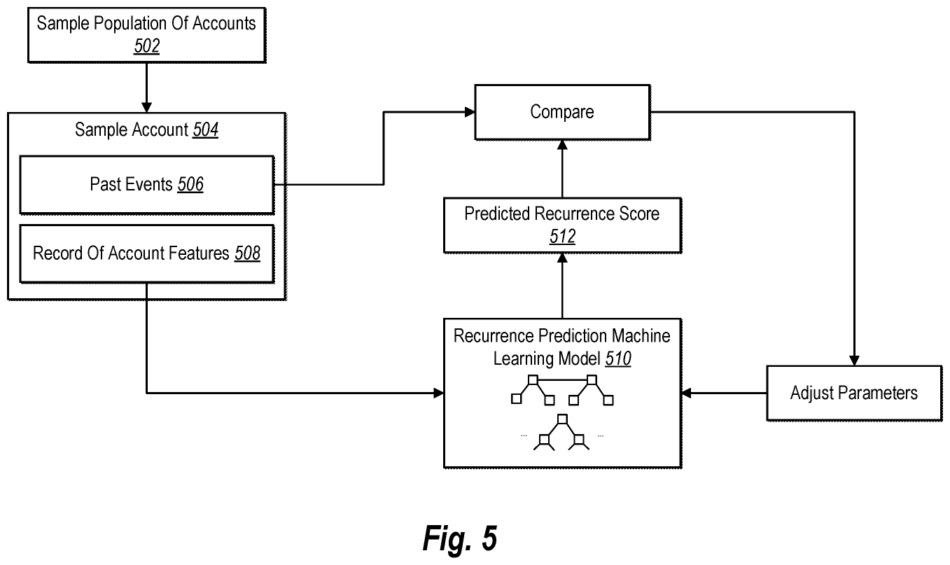

Accordingly, based on the account features 206, the event recurrence projection system 106 utilizes the recurrence prediction machine learning model 208 to generate the recurrence score 210. As stated previously, the recurrence score 210 indicates a likelihood that a detected account event will repeat within the network account 204. As discussed in greater detail below (e.g., in relation to FIG. 5), in some embodiments the recurrence prediction machine learning model 208 is trained utilizing historical data as ground truth data, including event histories of sample accounts and corresponding historical records of account features.

As further illustrated in FIG. 2, the recurrence incentive model 212 determines one or more responsive actions 214, based on the recurrence score 210, for increasing (or decreasing) the likelihood that the account event will repeat within the network account 204. For example, if the recurrence score 210 is below (or above) a threshold recurrence score (or within a predetermined range of recurrence scores), then the recurrence incentive model 212 may determine that a specific responsive action 214 should be taken to incentivize (or disincentivize) or otherwise influence the reoccurrence of the account event. In some embodiments, the recurrence incentive model 212 also considers the account features 206 when determining responsive action(s) 214. For example, in one or more embodiments, the recurrence prediction machine learning model 208 provides input to the recurrence incentive model 212, such as identification of which account features 206 affected the recurrence score 210 with greater magnitude relative to other features. Accordingly, in some embodiments, the recurrence prediction machine learning model 208 and the recurrence incentive model 212 operate in cooperation to determine effective responsive action(s) 214 for increasing (or decreasing) the likelihood that an account event will repeat within the network account 204.

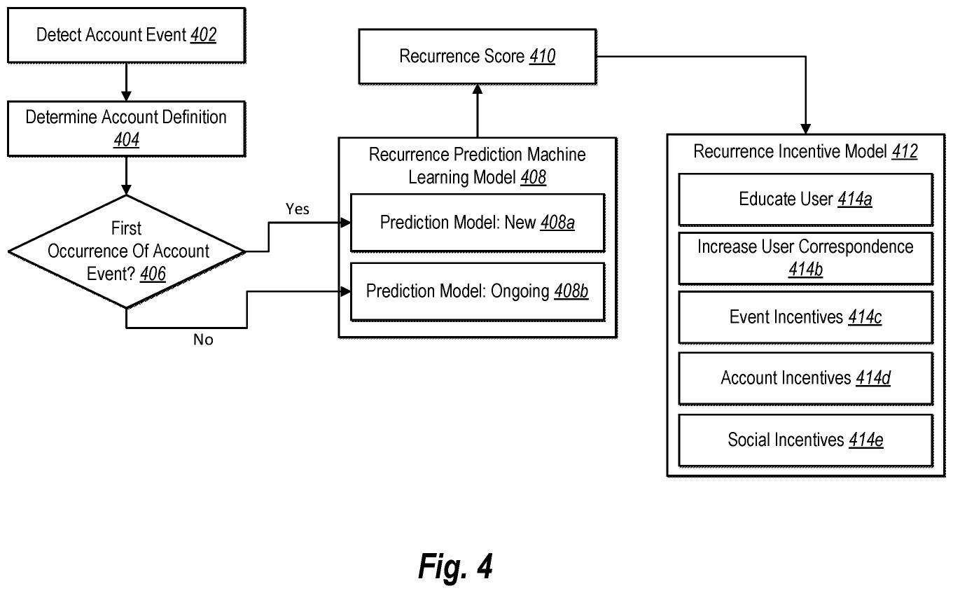

As mentioned above, responsive action(s) 214 can include a variety of actions configured to increase or decrease the likelihood of an account event reoccurring within the network account 204, thus increasing or decreasing the recurrence score 210 associated with that event. Accordingly, in some embodiments, an increasing recurrence score 210 is indicative of an increasing likelihood of event recurrence, whereas a decreasing recurrence score 210 is indicative of a decreasing likelihood of event recurrence. In one or more embodiments, for example, recurrence score 210 approaches 1.0 as the likelihood of recurrence increases. As a non-limiting example, the responsive action(s) 214 can include notifying a user of the network account 204 of one or more actions for increasing the likelihood that the account even will repeat within the network account 204. Additionally or alternatively, the responsive action(s) 214 can include one or more of providing an incentive to a user of the target account, providing information associated with the account definition to the user of the target account, or activating one or more application features associated with the target account. Additional responsive actions are discussed below in relation to FIG. 4.

As mentioned previously, the event recurrence projection system 106 can utilize a recurrence prediction machine learning model to generate a recurrence score based on a set of features associated with a target account. For example, FIG. 3 includes an exemplary list of account features that the event recurrence projection system 106 can utilize as inputs for a recurrence prediction machine learning model to generate recurrence scores. The account features listed are given as non-limiting example. As such, embodiments can include more or fewer account features than included in FIG. 3, as well as account features not listed in FIG. 3.

For example, as listed in FIG. 3, account events can include but are not limited to: whether the detected account event is a first occurrence for the target account, the source or origin of the account event, the number days passed since the detected account event, the relative magnitude of the account event, and so forth. Account resources can include but are not limited to the availability of resources related to the account event, such as account funds, memory, storage, computation resources, bandwidth, personnel, materials, or virtually any quantifiable resource determined to be relevant to the recurrence of the account event.

Additional account features listed include account activity, account usage, security events associated with the target account, account correspondence (e.g., correspondence between the account with other accounts, correspondence between the account owner and the account provider, etc.), enrollment data corresponding to the target account, attributes of the account user(s), data associated with third-party accounts related to the target account, and other metrics as found relevant to the account event.

As mentioned previously, the event recurrence projection system 106 can utilize a recurrence prediction machine learning model comprising multiple models specifically trained for varying circumstances, such as differences in event frequency and/or other account definitions. For example, FIG. 4 illustrates the event recurrence projection system 106 utilizing a recurrence prediction machine learning model 408 comprising a first prediction model 408a and a second prediction model 408b based on whether a detected account event is a first or subsequent occurrence within a target account.

As illustrated in FIG. 4, the event recurrence projection system 106 detects an account event at 402 and determines that the target account qualifies for an account definition at 404. For example, in some embodiments, the target account is designated with the account definition when the detected account event has occurred within a defined threshold time period. In some embodiments, for example, the event recurrence projection system 106 utilizes an account definition governed by a threshold time period to avoid monitoring and projecting recurrence of account events after a period of time upon which it is unlikely that the account event will reoccur. The threshold time period, for example, can be determined based on historical data comprising a record of event occurrences and reoccurrences within a sample population of accounts.

As further illustrated in FIG. 4, in some embodiments the event recurrence projection system 106 utilizes a recurrence prediction machine learning model 408 comprising two (or more) prediction models for determining a recurrence score 410. For instance, separately trained prediction models 408a and 408b can be implemented for differing circumstances, such as whether the account event detected at 402 was a first occurrence of the account event within the target account, as determined at 406. As shown, when the detected event is a first occurrence for the target account, the event recurrence projection system 106 utilizes the prediction model 408a to determine the recurrence score 410. However, if the detected event is a subsequent occurrence (i.e., not the first occurrence) of the account event within the target account, the event recurrence projection system 106 utilizes the prediction model 408b to determine the recurrence score 410. Accordingly, predictive models of the recurrence prediction machine learning model 408 can be individually trained to increase accuracy of generated recurrence scores under particular circumstances. Alternatively, in some embodiments, the event recurrence projection system 106 can utilize a single machine learning model to generate recurrence scores under a variety of circumstances. For example, in some embodiments, the event recurrence projection system 106 trains the recurrence prediction machine learning model 408 to deduce particular circumstances from input data received (e.g., as a parameter of a decision tree or other model).

In addition, as shown in FIG. 4, the event recurrence projection system 106 utilizes a recurrence incentive model 412 to determine one or more responsive actions based on recurrence score 410. As mentioned previously, the recurrence incentive model 412 can also utilize additional inputs from the recurrence prediction machine learning model 408 to determine actions for increasing (or decreasing) the recurrence score 410, such as but not limited to a designation by the recurrence prediction machine learning model 408 of which account features most affected the recurrence score 410.

Also, in some embodiments, the recurrence incentive model 412 determines that the recurrence score 410 falls below a defined threshold score and, in response, notifies a user of the target account of one or more actions for increasing the likelihood that the account event (detected at 402) will repeat within the target account. Similarly, in some embodiments, the recurrence incentive model 412 determines that the recurrence score 410 falls within a defined range of recurrence scores, such as one of a plurality of quantiles (e.g., one of five quintiles) representing a frequency distribution of recurrence scores within a population of accounts. Accordingly, in such embodiments, the event recurrence projection system 106 can utilize the recurrence incentive model 412 to determine actions for increasing (or decreasing) recurrence scores of account based on the quantile to which each respective account belongs.

Moreover, as shown in FIG. 4, the recurrence incentive model 412 includes various exemplary responsive actions 414a-e. However, the responsive actions 414a-e shown are given as non-limiting examples, whereas embodiments can include any number of responsive actions for increasing or decreasing the likelihood that an account event will repeat within a target account.

For instance, the recurrence incentive model 412 can determine one or more actions 414a to educate a user of the target account. For example, in some instances, user education with respect to causes, effects, rewards, and other factors associated with the account event detected at 402 can be effective in increasing (or decreasing) the likelihood that an account event will repeat within a target account.

Furthermore, in some instances, the recurrence incentive model 412 may determine to implement an action 414b for increasing user correspondence, such as but not limited to user correspondence with representatives of an account management system, with other users within the same system, or with a relevant third party.

Further still, in various circumstances, the recurrence incentive model 412 may determine to set forth one or more incentives to increase (or decrease) the likelihood that the account event will repeat within the target account. For example, responsive action 414c includes one or more event incentives targeted at incentivizing the account event itself (e.g., an offering or reward in response to reoccurrence of the account event). Responsive action 414d includes one or more incentives specifically targeted at the target account (e.g., an offering or reward for particular categories of account activity known to incentivize (or disincentivize) the account event). Responsive action 414e includes one or more incentives targeted at social media or other social interactions (e.g., an offering or reward to the user for interacting with and/or referring new users).

As mentioned previously, the event recurrence projection system 106 can utilize historical data corresponding to a sample population of accounts to train a recurrence prediction machine learning model. For example, FIG. 5 illustrates the event recurrence projection system 106 training a recurrence prediction machine learning model 510 utilizing past events 506 and a record of account features 508 corresponding to a sample account 504 of a sample population of accounts 502.

Specifically, the sample population of accounts 502 comprises a plurality of real network accounts for which relevant historical data is available. As shown in FIG. 5, the event recurrence projection system 106 utilizes known past events 506 and account features 508 corresponding to each sample account 504 of the sample population of accounts 502 to train the recurrence prediction machine learning model 510 to generate recurrence prediction scores for target accounts, the recurrence prediction score being indicative of a likelihood that an account event will repeat within each respective target account.

As illustrated, for a given sample event of the past events 506, the event recurrence projection system 106 utilizes the recurrence prediction machine learning model 510 to generate a predicted recurrence score 512 based on account features from the record of account features 508. For example, in certain implementations, the record of account features is sampled at various sample time frames relative to the sample event to determine account features for input to the recurrence prediction machine learning model 510.

In response to generating the predicted recurrence score 512, the event recurrence projection system 106 determines from the past events 506 whether the account event indeed did reoccur within the sample account 504. In some embodiments, the event recurrence projection system 106 only considers events that reoccurred within a defined threshold time period. Thus, the past events 506 (i.e., as ground truth) are compared with the predicted recurrence score 512 and the event recurrence projection system 106 adjusts one or more parameters of the recurrence prediction machine learning model 510 to increase the accuracy of generated recurrence scores. Accordingly, the foregoing process may be repeated across multiple sample accounts while considering multiple recorded past events and account features, and in light of multiple prediction time frames and threshold time periods.

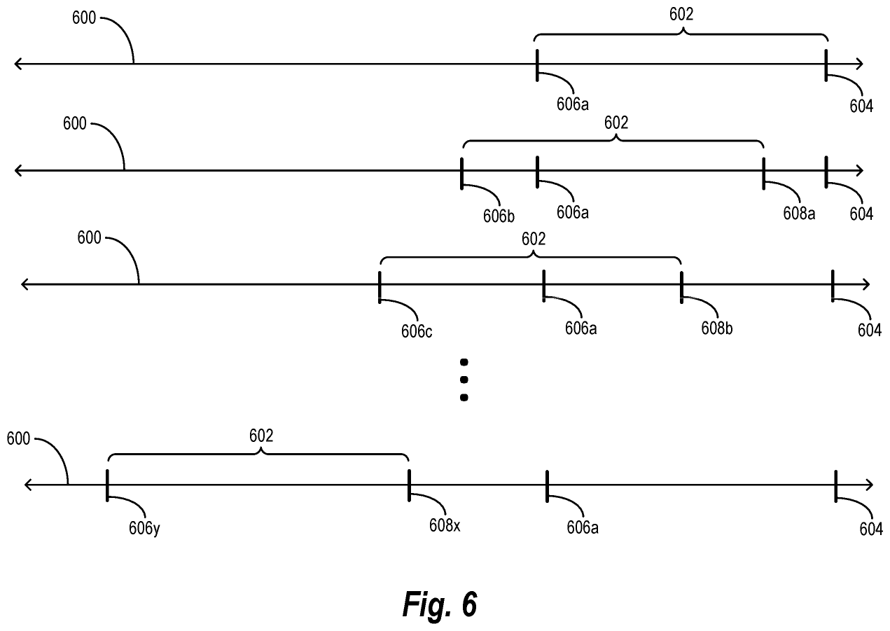

As mentioned previously, the event recurrence projection system 106 can utilize a dynamic prediction window to sample historical data for training a recurrence prediction machine learning model. For example, FIG. 6 illustrates the event recurrence projection system 106 utilizing a dynamic prediction window 602 to sample historic data, as represented by timeline 600. In particular, the timeline 600 represents known historical data for a sample population of accounts, the latest date of which is illustrated as end date 604. In some implementations, for example, end date 604 is the present day at which training of the model is implemented. In any case, the end date 604 is the final date for which validation data is available for training of the recurrence prediction machine learning model.

As shown in FIG. 6, the timeline 600 is sampled according to a dynamic prediction window 602. Specifically, the dynamic prediction window 602 is based on an assumed value of an unknown frequency for the account event for which the recurrence prediction machine learning model is trained to generate recurrence scores. In certain embodiments, for example, the event recurrence projection system 106 trains multiple recurrence prediction machine learning models, utilizing a different assumed frequency for each model. For example, for an assumed frequency of once every seven days, the dynamic prediction window 602 encompasses data within a seven-day window of timeline 600. Accordingly, when a predicted recurrence score is generated for a particular date on timeline 600, the ground truth date for that predicted recurrence score would be seven days later, at which the historical record would indicate whether the account event has repeated.

Indeed, in the illustrated embodiment, the dynamic prediction window 602 dictates the dates on timeline 600 from which a prediction is made and from which the same prediction is validated. Furthermore, the dynamic prediction window 602 can be adjusted according to event frequencies observed in historical data and/or a plurality of assumed values (e.g., seven days, fourteen days, one month, 32 days, or 90 days) can be implemented to train a recurrence prediction machine learning model (or multiple recurrence prediction machine learning models) according to one or more embodiments.

As further illustrated in FIG. 6, the event recurrence projection system 106 utilizes the dynamic prediction window 602 to sample the timeline 600 at a plurality of dates (or any other time unit should the assumed value of unknown frequency not be in days) to train a recurrence prediction machine learning model. For instance, starting with end date 604 as a first validation date, the event recurrence projection system 106 samples account features at date 606a according to the magnitude of the dynamic prediction window 602. Accordingly, the recurrence prediction machine learning model generates a predicted recurrence score at date 606a based on recorded account features at date 606a and utilizes event occurrence data (i.e., whether the account event reoccurred) at end date 604 as ground truth for training the model.

In addition, the event recurrence projection system 106 shifts the dynamic prediction window 602 to sample the data at various moments in time. As shown, for example, another sample comprises a sample date 606b with a corresponding validation date 608a at which the event recurrence projection system 106 trains the recurrence prediction machine learning model according to whether the event has reoccurred at the validation date 608a. Similarly, yet another sample comprises a sample date 606c with a corresponding validation date 608b. Accordingly, the timeline 600 is sampled according to the dynamic prediction window 602 until a prediction date 606y, with corresponding validation date 608x, that are the most prior sample date for which event and feature data is available. Indeed, the event recurrence projection system 106 implements the dynamic prediction window 602 to repeatedly sample the timeline 600 for a plurality of prediction and validation points for training of a recurrence prediction machine learning model.

To further illustrate, in one or more embodiments, the event recurrence projection system 106 can project recurrence of direct deposits or other network transactions within user accounts of a financial network. Accordingly, the event recurrence projection system 106 can project recurrence of direct deposits utilizing a recurrence prediction machine learning model trained on historic data associated with a sample population of sample accounts.

Indeed, upon detecting that a direct deposit has taken place within a target account, the event recurrence projection system 106 can generate recurrence scores indicating a likelihood that a target account will repeat a direct deposit within the target account. Furthermore, the event recurrence projection system 106 can utilize recurrence scores and/or account features to determine one or more responsive actions for increasing the likelihood that a direct deposit will reoccur within the target account.

As mentioned previously, the event recurrence projection system 106 can utilize a variety of account features as input for a recurrence prediction machine learning model and/or a recurrence incentive model. For instance, FIGS. 7A-7C include an exemplary list of account features that the event recurrence projection system 106 can utilize as inputs for a recurrence prediction machine learning model to generate recurrence scores related to direct deposit recurrence or recurrence of other network transactions within a target account of a financial network. Indeed, embodiments include additional features (or fewer features) for input into the recurrence prediction machine learning model to generate recurrence scores and determine responsive actions for increasing the likelihood that a direct deposit or other transaction will repeat within a target account.

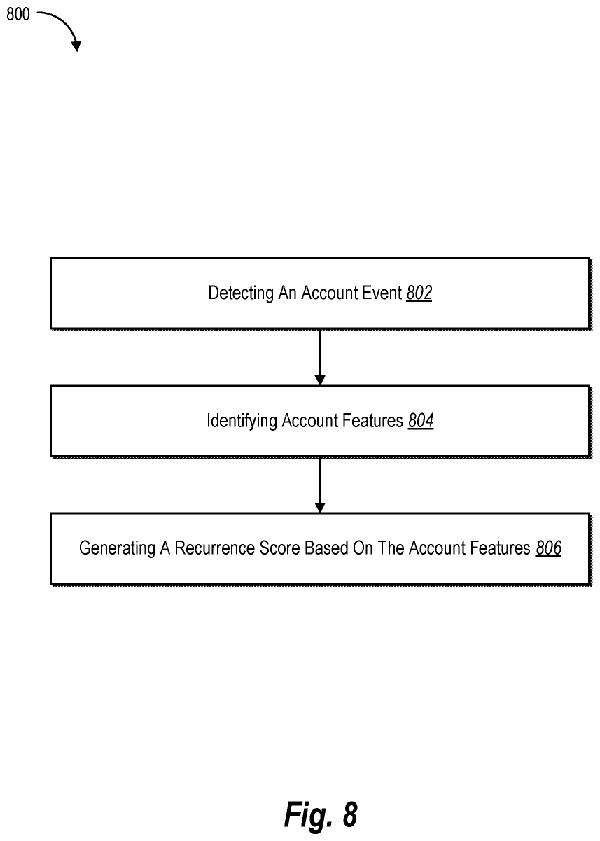

FIGS. 1-6 and 7A-7C, the corresponding text, and the examples provide a number of different methods, systems, devices, and non-transitory computer-readable media of the event recurrence projection system 106. In addition to the foregoing, one or more embodiments can also be described in terms of flowcharts comprising acts for accomplishing a particular result, as shown in FIG. 8. FIG. 8 may be performed with more or fewer acts. Further, the acts may be performed in differing orders. Additionally, the acts described herein may be repeated or performed in parallel with one another or parallel with different instances of the same or similar acts.

While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer-readable medium can comprise instructions that, when executed by one or more processors, cause a computing device to perform the acts of FIG. 8. In some embodiments, a system can perform the acts of FIG. 8. Additionally, the acts described herein may be repeated or performed in parallel with one another or in parallel with different instances of the same or other similar acts.

As shown, FIG. 8 illustrates an example series of acts 800 for projecting recurrence of account events within network accounts. For instance, the series of acts 800 can include an act 802 for detecting an account event. In particular, the act 802 can include determining that a target account qualifies for an account definition based on an account event occurring within a defined threshold time period, the account event being a periodic event of an unknown frequency.

As also shown in FIG. 8, the series of acts 800 can include an act 804 for identifying account features. In particular, the act 804 can include identifying a set of features associated with the target account based on determining the target account qualified for the account definition. In some embodiments, the set of features associated with the target account comprises one or more of event data associated with the account event, availability of target account resources, target account activity data, security incidents associated with the target account, correspondence history of the target account, or target account age.

In addition, as shown in FIG. 8, the series of acts 800 can include an act 806 for generating a recurrence score based on the account features. In particular, the act 806 can include utilizing a recurrence prediction machine learning model to generate a recurrence score, based on the set of features, that indicates a likelihood that the account event will repeat within the target account. In some embodiments, the recurrence prediction machine learning model comprises a first model configured to generate recurrence scores for target accounts having experienced one occurrence of the periodic event, and a second model configured to generate recurrence scores for target accounts having experienced two or more occurrences of the periodic event.

Additionally, the series of acts 800 can include an act for training the recurrence prediction machine learning model utilizing historical data corresponding to a sample population of accounts by sampling the historical data according to one or more assumed values of the unknown frequency. In one or more embodiments, the one or more assumed values comprise one or more of seven days, fourteen days, one month, 32 days, or 90 days. In some embodiments, training the recurrence prediction machine learning model is repeated for a plurality of assumed values of the unknown frequency.

Furthermore, in some embodiments, training the recurrence prediction machine learning model further comprises an act for determining, from a sample account history of a sample account of the sample population, a sample set of features associated with the sample account at a time after occurrence of a past account event, the time after occurrence corresponding to an assumed value of the unknown frequency. Also, in some embodiments, training the recurrence prediction machine learning model includes an act for, based on the sample set of features, utilizing the recurrence prediction machine learning model to generate a sample recurrence score for the sample account corresponding to the time after occurrence. In addition, in some embodiments, training the recurrence prediction machine learning model includes an act for, based on a comparison of the sample recurrence score and the sample account history, adjusting the one or more parameters of the recurrence prediction machine learning model.

In addition, in some embodiments, the series of acts 800 can include an act for determining that the recurrence score falls below a defined threshold score and, in response, notifying a user of the target account of one or more actions for increasing the likelihood that the account event will repeat within the target account. Additionally or alternatively, in some embodiments, the series of acts 800 can include an act for, in response to determining that the recurrence score falls below the defined threshold score or within a defined range of scores (e.g., within a quantile of a frequency distribution of recurrence scores for a population of accounts), performing one or more actions comprising at least one of: providing an incentive to a user of the target account, providing information associated with the account definition to the user of the target account, or activating one or more application features associated with the target account.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 9 illustrates a block diagram of an example computing device 900 that may be configured to perform one or more of the processes described above. In one or more embodiments, the computing device 900 may be a mobile device (e.g., a mobile telephone, a smartphone, a PDA, a tablet, a laptop, a camera, a tracker, a watch, a wearable device, etc.). In some embodiments, the computing device 900 may be a non-mobile device (e.g., a desktop computer or another type of client device). Further, the computing device 900 may be a server device that includes cloud-based processing and storage capabilities.

As shown in FIG. 9, the computing device 900 can include one or more processor(s) 902, memory 904, a storage device 906, input/output interfaces 908 (or “I/O interfaces 908”), and a communication interface 910, which may be communicatively coupled by way of a communication infrastructure (e.g., bus 912). While the computing device 900 is shown in FIG. 9, the components illustrated in FIG. 9 are not intended to be limiting. Additional or alternative components may be used in other embodiments. Furthermore, in certain embodiments, the computing device 900 includes fewer components than those shown in FIG. 9. Components of the computing device 900 shown in FIG. 9 will now be described in additional detail.

In particular embodiments, the processor(s) 902 includes hardware for executing instructions, such as those making up a computer program. As an example, and not by way of limitation, to execute instructions, the processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, the storage device 906 can include a non-transitory storage medium described above. The storage device 906 may include a hard disk drive (HDD), flash memory, a Universal Serial Bus (USB) drive or a combination these or other storage devices.

As shown, the computing device 900 includes one or more I/O interfaces 908, which are provided to allow a user to provide input to (such as user strokes), receive output from, and otherwise transfer data to and from the computing device 900. These I/O interfaces 908 may include a mouse, keypad or a keyboard, a touch screen, camera, optical scanner, network interface, modem, other known I/O devices or a combination of such I/O interfaces 908. The touch screen may be activated with a stylus or a finger.

The I/O interfaces 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 908 are configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 provides one or more interfaces for communication (such as, for example, packet-based communication) between the computing device and one or more other computing devices or one or more networks. As an example, and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can include hardware, software, or both that connects components of computing device 900 to each other.

FIG. 10 illustrates an example network environment 1000 of the event recurrence projection system 106. The network environment 1000 includes a client device 1006 (e.g., client device 108), an event recurrence projection system 106, and a third-party system 1008 connected to each other by a network 1004. Although FIG. 10 illustrates a particular arrangement of the client device 1006, the event recurrence projection system 106, the third-party system 1008, and the network 1004, this disclosure contemplates any suitable arrangement of client device 1006, the event recurrence projection system 106, the third-party system 1008, and the network 1004. As an example, and not by way of limitation, two or more of client device 1006, the event recurrence projection system 106, and the third-party system 1008 communicate directly, bypassing network 1004. As another example, two or more of client device 1006, the event recurrence projection system 106, and the third-party system 1008 may be physically or logically co-located with each other in whole or in part.

Moreover, although FIG. 10 illustrates a particular number of client devices 1006, event recurrence projection systems 104, third-party systems 1008, and networks 1004, this disclosure contemplates any suitable number of client devices 1006, event recurrence projection system 106, third-party systems 1008, and networks 1004. As an example, and not by way of limitation, network environment 1000 may include multiple client devices 1006, event recurrence projection system 106, third-party systems 1008, and/or networks 1004.

This disclosure contemplates any suitable network 1004. As an example, and not by way of limitation, one or more portions of network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1004 may include one or more networks 1004.

Links may connect client device 1006, the event recurrence projection system 106, and third-party system 1008 to network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, the client device 1006 may be an electronic device including hardware, software, or embedded logic components or a combination of two or more such components and capable of carrying out the appropriate functionalities implemented or supported by client device 1006. As an example, and not by way of limitation, a client device 1006 may include any of the computing devices discussed above in relation to FIG. 9. A client device 1006 may enable a network user at the client device 1006 to access network 1004. A client device 1006 may enable its user to communicate with other users at other client devices 1006.

In particular embodiments, the client device 1006 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1006 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1006 one or more Hyper Text Markup Language (“HTML”) files responsive to the HTTP request. The client device 1006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, event recurrence projection system 106 may be a network-addressable computing system that can interface between two or more computing networks or servers associated with different entities such as financial institutions (e.g., banks, credit processing systems, ATM systems, or others). In particular, the event recurrence projection system 106 can send and receive network communications (e.g., via the network 1004) to link the third-party system 1008. For example, the event recurrence projection system 106 may receive authentication credentials from a user to link a third-party system 1008 such as an online banking system to link an online bank account, credit account, debit account, or other financial account to a user account within the event recurrence projection system 106. The event recurrence projection system 106 can subsequently communicate with the third-party system 1008 to detect or identify balances, transactions, withdrawal, transfers, deposits, credits, debits, or other transaction types associated with the third-party system 1008. The event recurrence projection system 106 can further provide the aforementioned or other financial information associated with the third-party system 1008 for display via the client device 1006. In some cases, the event recurrence projection system 106 links more than one third-party system 1008, receiving account information for accounts associated with each respective third-party system 1008 and performing operations or transactions between the different systems via authorized network connections.

In particular embodiments, the event recurrence projection system 106 may interface between an online banking system and a credit processing system via the network 1004. For example, the event recurrence projection system 106 can provide access to a bank account of a third-party system 1008 and linked to a user account within the event recurrence projection system 106. Indeed, the event recurrence projection system 106 can facilitate access to, and transactions to and from, the bank account of the third-party system 1008 via a client application of the event recurrence projection system 106 on the client device 1006. The event recurrence projection system 106 can also communicate with a credit processing system, an ATM system, and/or other financial systems (e.g., via the network 1004) to authorize and process credit charges to a credit account, perform ATM transactions, perform transfers (or other transactions) between user accounts or across accounts of different third-party systems 1008, and to present corresponding information via the client device 1006.

In particular embodiments, the event recurrence projection system 106 includes a model (e.g., a machine learning model) for approving or denying transactions. For example, the event recurrence projection system 106 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the event recurrence projection system 106 and/or one or more third-party systems 1008), the event recurrence projection system 106 can utilize the transaction approval machine learning model to generate a prediction (e.g., a percentage likelihood) of approval or denial of a transaction (e.g., a withdrawal, a transfer, or a purchase) across one or more networked systems.

The event recurrence projection system 106 may be accessed by the other components of network environment 1000 either directly or via network 1004. In particular embodiments, the event recurrence projection system 106 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the event recurrence projection system 106 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1006, or an event recurrence projection system 106 to manage, retrieve, modify, add, or delete, the information stored in data store.

In particular embodiments, the event recurrence projection system 106 may provide users with the ability to take actions on various types of items or objects, supported by the event recurrence projection system 106. As an example, and not by way of limitation, the items and objects may include financial institution networks for banking, credit processing, or other transactions, to which users of the event recurrence projection system 106 may belong, computer-based applications that a user may use, transactions, interactions that a user may perform, or other suitable items or objects. A user may interact with anything that is capable of being represented in the event recurrence projection system 106 or by an external system of a third-party system, which is separate from event recurrence projection system 106 and coupled to the event recurrence projection system 106 via a network 1004.

In particular embodiments, the event recurrence projection system 106 may be capable of linking a variety of entities. As an example, and not by way of limitation, the event recurrence projection system 106 may enable users to interact with each other or other entities, or to allow users to interact with these entities through an application programming interfaces (“API”) or other communication channels.

In particular embodiments, the event recurrence projection system 106 may include a variety of servers, sub-systems, programs, modules, logs, and data stores. In particular embodiments, the event recurrence projection system 106 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The event recurrence projection system 106 may also include suitable components such as network interfaces, security mechanisms, load balancers, failover servers, management-and-network-operations consoles, other suitable components, or any suitable combination thereof. In particular embodiments, the event recurrence projection system 106 may include one or more user-profile stores for storing user profiles and/or account information for credit accounts, secured accounts, secondary accounts, and other affiliated financial networking system accounts. A user profile may include, for example, biographic information, demographic information, financial information, behavioral information, social information, or other types of descriptive information, such as interests, affinities, or location.

The web server may include a mail server or other messaging functionality for receiving and routing messages between the event recurrence projection system 106 and one or more client devices 1006. An action logger may be used to receive communications from a web server about a user's actions on or off the event recurrence projection system 106. In conjunction with the action log, a third party-content-object log may be maintained of user exposures to third party-content objects. A notification controller may provide information regarding content objects to a client device 1006. Information may be pushed to a client device 1006 as notifications, or information may be pulled from client device 1006 responsive to a request received from client device 1006. Authorization servers may be used to enforce one or more privacy settings of the users of the event recurrence projection system 106. A privacy setting of a user determines how particular information associated with a user can be shared. The authorization server may allow users to opt in to or opt out of having their actions logged by the event recurrence projection system 106 or shared with other systems, such as, for example, by setting appropriate privacy settings. Third party-content-object stores may be used to store content objects received from third parties. Location stores may be used for storing location information received from client devices 1006 associated with users.

In addition, the third-party system 1008 can include one or more computing devices, servers, or sub-networks associated with internet banks, central banks, commercial banks, retail banks, credit processors, credit issuers, ATM systems, credit unions, loan associates, brokerage firms, linked to the event recurrence projection system 106 via the network 1004. A third-party system 1008 can communicate with the event recurrence projection system 106 to provide financial information pertaining to balances, transactions, and other information, whereupon the event recurrence projection system 106 can provide corresponding information for display via the client device 1006. In particular embodiments, a third-party system 1008 communicates with the event recurrence projection system 106 to update account balances, transaction histories, credit usage, and other internal information of the event recurrence projection system 106 and/or the third-party system 1008 based on user interaction with the event recurrence projection system 106 (e.g., via the client device 1006). Indeed, the event recurrence projection system 106 can synchronize information across one or more third-party systems 1008 to reflect accurate account information (e.g., balances, transactions, etc.) across one or more networked systems, including instances where a transaction (e.g., a transfer) from one third-party system 1008 affects another third-party system 1008.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
determining that a target account qualifies for an account definition based on an account event occurring within a defined threshold time period, the account event being a periodic event of an unknown frequency;
based on determining the target account qualified for the account definition, identifying a set of features associated with the target account; and
based on the set of features, utilizing a recurrence prediction machine learning model to generate a recurrence score that indicates a likelihood that the account event will repeat within the target account.

2. The computer-implemented method of claim 1, further comprising training the recurrence prediction machine learning model utilizing historical data corresponding to a sample population of accounts by sampling the historical data according to one or more assumed values of the unknown frequency.

3. The computer-implemented method of claim 2, wherein the one or more assumed values comprise one or more of seven days, fourteen days, one month, 32 days, or 90 days.

4. The computer-implemented method of claim 2, wherein training the recurrence prediction machine learning model further comprises:
determining, from a sample account history of a sample account of the sample population, a sample set of features associated with the sample account at a time after occurrence of a past account event, the time after occurrence corresponding to an assumed value of the unknown frequency;
based on the sample set of features, utilizing the recurrence prediction machine learning model to generate a sample recurrence score for the sample account corresponding to the time after occurrence; and
based on a comparison of the sample recurrence score and the sample account history, adjusting one or more parameters of the recurrence prediction machine learning model.

5. The computer-implemented method of claim 1, wherein the recurrence prediction machine learning model comprises:
a first model configured to generate recurrence scores for target accounts having experienced one occurrence of the periodic event; and
a second model configured to generate recurrence scores for target accounts having experienced two or more occurrences of the periodic event.

6. The computer-implemented method of claim 1, wherein the set of features associated with the target account comprises one or more of:
event data associated with the account event, availability of target account resources, target account activity data, security incidents associated with the target account, correspondence history of the target account, or target account age.

7. The computer-implemented method of claim 1, further comprising:
determining that the recurrence score falls below a defined threshold score or within a defined range of scores; and
in response, notifying a user of the target account of one or more actions for increasing the likelihood that the account event will repeat within the target account.

8. The computer-implemented method of claim 1, further comprising:
determining that the recurrence score falls below a defined threshold score or within a defined range of scores; and
in response, performing one or more actions comprising at least one of: providing an incentive to a user of the target account, providing information associated with the account definition to the user of the target account, or activating one or more application features associated with the target account.

9. A non-transitory computer-readable medium storing executable instructions, which when executed by at least one processor, cause the at least one processor to perform operations comprising:
determining that a target account qualifies for an account definition based on an account event occurring within a defined threshold time period, the account event being a periodic event of an unknown frequency;
based on determining the target account qualified for the account definition, identifying a set of features associated with the target account; and
based on the set of features, utilizing a recurrence prediction machine learning model to generate a recurrence score that indicates a likelihood that the account event will repeat within the target account.

10. The non-transitory computer-readable medium of claim 9, further comprising instructions that, when executed by the at least one processor, cause the at least one processor to perform operations comprising training the recurrence prediction machine learning model by:
determining, from a sample account history of a sample account, a sample set of features associated with the sample account at a time after occurrence of a past account event, the time after occurrence corresponding to an assumed value of the unknown frequency;
based on the sample set of features, utilizing the recurrence prediction machine learning model to generate a sample recurrence score for the sample account corresponding to the time after occurrence; and
based on a comparison of the sample recurrence score and the sample account history, adjusting one or more parameters of the recurrence prediction machine learning model.

11. The non-transitory computer-readable medium of claim 10, wherein training the recurrence prediction machine learning model is repeated for a plurality of assumed values of the unknown frequency.

12. The non-transitory computer-readable medium of claim 11, wherein the plurality of assumed values of the unknown frequency comprises two or more of seven days, fourteen days, one month, 32 days, or 90 days.

13. The non-transitory computer-readable medium of claim 9, wherein the recurrence prediction machine learning model comprises:
a first model configured to generate recurrence scores for target accounts having experienced one occurrence of the periodic event; and
a second model configured to generate recurrence scores for target accounts having experienced two or more occurrences of the periodic event.

14. The non-transitory computer-readable medium of claim 9, wherein the set of features associated with the target account comprises one or more of:
event data associated with the account event, availability of target account resources, target account activity data, security incidents associated with the target account, correspondence history of the target account, or target account age.

15. A system comprising:
one or more memory devices comprising a recurrence prediction machine learning model; and
one or more processors configured to cause the system to:
determine that a target account qualifies for an account definition based on an account event occurring within a defined threshold time period, the account event being a periodic event of an unknown frequency;
based on determining the target account qualified for the account definition, identify a set of features associated with the target account; and
based on the set of features, utilize a recurrence prediction machine learning model to generate a recurrence score that indicates a likelihood that the account event will repeat within the target account.

16. The system of claim 15, wherein the one or more processors are further configured to cause the system to train the recurrence prediction machine learning model utilizing historical data corresponding to a sample population of accounts by sampling the historical data according to one or more assumed values of the unknown frequency.

17. The system of claim 16, wherein the one or more assumed values comprise one or more of seven days, fourteen days, one month, 32 days, or 90 days.

18. The system of claim 15, wherein the set of features associated with the target account comprises one or more of:
event data associated with the account event, availability of target account resources, target account activity data, security incidents associated with the target account, correspondence history of the target account, or target account age.

19. The system of claim 15, wherein the one or more processors are further configured to cause the system to:
determine that the recurrence score falls below a defined threshold score or within a defined range of scores; and
in response, notify a user of the target account of one or more action for increasing the likelihood that the account event will repeat within the target account.

20. The system of claim 15, wherein the one or more processors are further configured to cause the system to:
determine that the recurrence score falls below a defined threshold score or within a defined range of scores; and
in response, perform one or more actions comprising at least one of: providing an incentive to a user of the target account, providing information associated with the account definition to the user of the target account, or activating one or more application features associated with the target account.
